(19) United States
(12) Patent Application Publication
(10) Pub. No.: US 2020/0085124 A1
(43) Pub. Date: Mar. 19, 2020

(54) Sanitary Mask

(71) Applicant: Zeppelin Corporation, Apia (WS)

(72) Inventor: Kuo-Ching Chiang, New Taipei (TW)

(21) Appl. No.: 16/223,082

(22) Filed: Dec. 17, 2018

(30) Foreign Application Priority Data
Sep. 19, 2018 (TW) 107132943

(51) Int. Cl. A41D 31/32; A41D 13/11; D06P 1/00

(52) U.S. Cl. CPC A41D 31/325; A41D 13/1107; B32B 3/266; D06P 1/00; A41D 2400/26; A41D 13/1192

(57) ABSTRACT

The present invention discloses a sanitary mask, including: a first anti-UV layer having a plurality of first holes distributed irregularly; a second anti-UV layer having a plurality of second holes distributed irregularly and disposed adjacent to the first anti-UV layer; a filtering layer disposed adjacent to the second anti-UV layer; and an inner layer disposed adjacent to the filtering layer.

### CROSS-REFERENCE TO RELATED APPLICATIONS

The present application is based on, and claims priority from, Taiwan Application Serial Number 107132943, filed Sep. 19, 2018, the disclosure of which is hereby incorporated by reference herein in its entirety.

### TECHNICAL FIELD

The disclosure of the present invention relates to a mask, and particularly to a sanitary mask and the manufacturing method thereof.

### BACKGROUND

Recently, the ultraviolet ray is extremely strong, and thus affects the recovery after facial cosmetic surgery especially seriously. Currently, all of the sanitary masks on the market only have the function of filtering out dust only. However, the traditional mask is unable to have anti-UV function and fail to have the function of generating heat and defending against cold.

### SUMMARY

The present invention relates to a sanitary mask with the following properties. The present invention provides a method for manufacturing a mask, including: preparing a dip solution, the dip solution includes photochromic dye and resin; and moving a substrate via a roll to roll device to render the substrate to pass through a dipping tank having the dip solution, such that the substrate adsorbs the dip solution to form an anti-UV material on the substrate, the substrate with the anti-UV material thereon generates change in color after illuminated by ultraviolet radiation. In one embodiment, the mixing ratio of the photochromic dye and the resin may be about 1:5 to about 1:20. The present method may further include drying the substrate. In one embodiment, the drying may be performed under a temperature of below 150 degrees Celsius. In one embodiment, the substrate may include unwoven fabric. In one embodiment, the substrate may include polypropylene fiber (PP).

A method for manufacturing a substrate, including: preparing a dip solution, the dip solution includes photochromic dye and resin; and moving a substrate via a roll to roll device to render the substrate to pass through a dipping tank having the dip solution to form an anti-UV material on the substrate. In one embodiment, the mixing ratio of the photochromic dye and the resin may be about 1:5 to about 1:20. The present method may further include drying the substrate. In one embodiment, the drying may be performed under a temperature of below 150 degrees Celsius. In one embodiment, the substrate may include polypropylene fiber (PP) unwoven fabric.

The present invention discloses a sanitary mask, including: an inner layer; a middle layer disposed on the inner layer; and an outer layer disposed on the middle layer, wherein the step for manufacturing the outer layer includes: preparing a dip solution, the dip solution includes photochromic dye and resin; and moving a substrate via a roll to roll device to render the substrate to pass through a dipping tank having the dip solution, such that the substrate adsorbs the dip solution to form an anti-UV material on the substrate, the substrate with the anti-UV material thereon generates change in color after illuminated by ultraviolet radiation. In one embodiment, the mixing ratio of the photochromic dye and the resin may be about 1:5 to about 1:20.

The present invention discloses a sanitary mask, including: an inner layer, wherein the step for manufacturing the inner layer includes: preparing a dip solution, the dip solution includes scent molecules; and moving a substrate via a roll to roll device to render the substrate to pass through a dipping tank having the dip solution, such that the substrate adsorbs the scent molecules and has the scent; a middle layer disposed on the inner layer; and an outer layer disposed on the middle layer. The present invention discloses a sanitary mask, including: an inner layer; a middle layer disposed on the inner layer, wherein the step for manufacturing the middle layer includes: preparing a dip solution, the dip solution includes lysozyme; and rendering a substrate of the middle layer to pass through a dipping tank having the dip solution, such that the substrate of the middle layer adsorbs the lysozyme; and an outer layer disposed on the middle layer

A sanitary mask, including: an outer layer; a middle layer disposed on the outer layer; and an inner layer and the material of the inner layer including hollow fiber, phase change fiber, ceramic material fiber or heat generating fiber or the combination thereof. The outer layer may include UV absorbent or photochromic dye or the combination thereof. The middle layer may include a nano-micro-perforated Poly(tetrafluoroethene)(PTFE) membrane. The inner layer may include scent molecules absorbed therein. The middle layer or the outer layer may include antibacterial composition, enzyme or anti-influenza substance or the combination thereof.

A sanitary mask, including: an outer layer; a middle layer disposed on the outer layer, wherein the middle layer may include nano-micro-perforated Poly(tetrafluoroethene)(PTFE) membrane; and an inner layer and the material of the inner layer including hollow fiber, phase change fiber, ceramic material fiber or heat generating fiber or the combination thereof. The outer layer may include UV absorbent or photochromic dye or the combination thereof.

A sanitary mask, including: an outer layer, wherein the outer layer may include antibacterial composition, enzyme or anti-influenza substance or the combination thereof a middle layer disposed on the outer layer; and an inner layer and the material of the inner layer including hollow fiber, phase change fiber, ceramic material fiber or heat generating fiber or the combination thereof. The middle layer may include nano-micro-perforated Poly(tetrafluoroethene)(PTFE) membrane.

A sanitary mask, including: an outer layer; a filtering layer disposed adjacent to the outer layer; and a warmth keeping layer disposed at the inner side or the outer side of the filtering layer, wherein the warmth keeping layer includes readily oxidizable metal, water absorbent material and salt. In one embodiment, the readily oxidizable metal may include iron, magnesium or zinc or the combination thereof. In one embodiment, the water absorbent material may include activated carbon or silicate or the combination thereof. In one embodiment, the salt may include table salt. In one embodiment, the outer layer may include UV absorbent or photochromic dye or the combination thereof. The filtering layer may be selected from one of HEPA, polyester-ether (TPEE), copolymer of phenyl ester and polyether diol (TEEE), polyurethane elastomer (TPU), Poly(tetrafluoroethene)(PTFE), polypropylene (PP), polyethylene (PE). The sanitary mask may further include an inner layer. In one embodiment, the filtering layer or the outer layer may include antibacterial composition. In one embodiment, the filtering layer or the outer layer may include enzyme. In one embodiment, the filtering layer or the outer layer may include anti-influenza substance.

A sanitary mask, including: a first anti-UV layer having a plurality of first holes distributed irregularly; a second anti-UV layer having a plurality of second holes distributed irregularly and disposed adjacent to the first anti-UV layer; a filtering layer disposed adjacent to the second anti-UV layer; and an inner layer disposed adjacent to the filtering layer. In one embodiment, the first anti-UV layer may include UV absorbent or photochromic dye or the combination thereof. In one embodiment, the second anti-UV layer may include UV absorbent or photochromic dye or the combination thereof. In one embodiment, the plurality of first holes may be arranged randomly, and the plurality of second holes may be arranged randomly. In one embodiment, if a whole amount of anti-UV compositions is fixed, the first anti-UV layer and the second anti-UV layer may include a half of the whole amount of anti-UV compositions respectively. Namely, the amount of anti-UV compositions in the first anti-UV layer is the same with the amount of anti-UV compositions in the second anti-UV layer.

A sanitary mask, including: a first anti-UV layer having a plurality of first holes distributed irregularly, the first anti-UV layer including a first photochromic dye; a second anti-UV layer having a plurality of second holes distributed irregularly and disposed adjacent to the first anti-UV layer, the second anti-UV layer including a second photochromic dye; a filtering layer disposed adjacent to the second anti-UV layer; and an inner layer disposed adjacent to the filtering layer. In one embodiment, the plurality of first holes may be arranged randomly, and the plurality of second holes may be arranged randomly. In one embodiment, an amount of the first photochromic dye is about equivalent to an amount of the second photochromic dye. In one embodiment, a color of the first photochromic dye is identical to a color of the second photochromic dye. In one embodiment, a color of the first photochromic dye is different from a color of the second photochromic dye. If the colors of the two anti-UV layers are identical, the color synergistic effect will be enhanced. If the colors of the two anti-UV layers are different, the color mixing effect can be achieved.

### BRIEF DESCRIPTION OF THE DRAWINGS

FIG. 1 illustrates a device of the present invention;

FIG. 2 illustrates a manufacturing process of the present invention;

FIG. 3 illustrates a sanitary mask of the present invention;

FIG. 4A illustrates the structure of the UV absorption layer of the present invention;

FIG. 4B illustrates the test report of the sanitary mask of the present invention, showing that the UV filtering effect of the sanitary mask is outstanding; and

FIG. 5 illustrates a sanitary mask of the present invention.

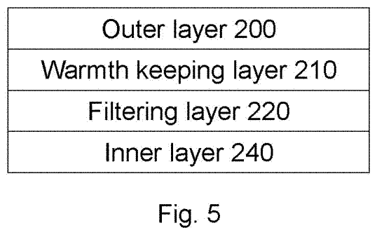

### DETAILED DESCRIPTION

Generally, a sanitary mask at least includes three layers including an inner layer, a middle layer as a filter layer and an outer layer. The sanitary mask of the present invention includes a substrate including the outer layer manufactured by the following process, so as to have UV protection function.

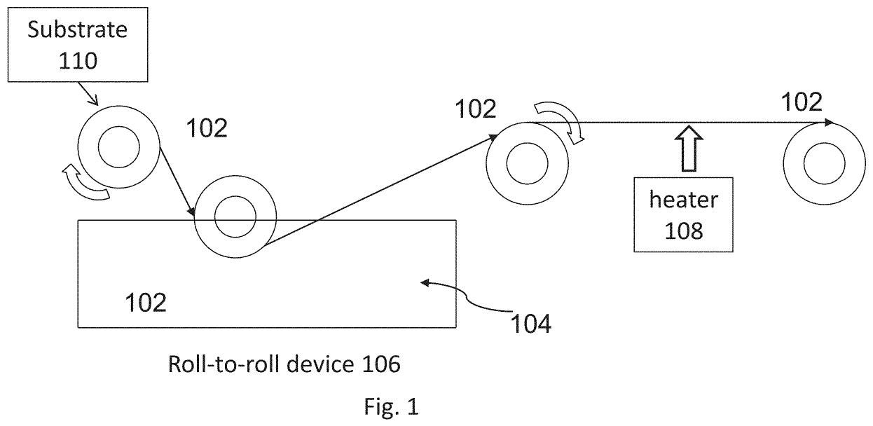

A roll to roll device 106 is configured such that the roll to roll device 106 at least includes three rolls 102, wherein at least one roll is disposed in a dye tank 104. The dye tank 104 is employed to be loaded with dye. The rolls 102 may be driven by driving devices such as motors, so as to render them to rotate around an axis of rotation respectively and tug the soft substrate to move for example as shown by the curved arrow in FIG. 1, such that the substrate 110 may be moved from one end to another end. During the process, the substrate 110 will be driven to move and pass through the dye tank 104, where the anti-UV dye will be attached onto the substrate 110. The rotation speed of the rolls 102 may be controlled, thereby controlling the moving speed, so as to control the thickness of the material. The heating device 108 is correspondingly disposed adjacent to the moving substrate 110 and may be optionally actuated to provide heating source for the drying process. The heating device 108 may be lamp, hot blast, electromagnetic radiation or infrared ray heater.

As the manufacturing process progresses, the substrate is moved from one unprinted end to another end. At this time, the printed substrate will be moved to another end to be collected. The printed substrate can be rolled at another end because the substrate is flexible. If necessary, the heating device may be actuated to provide the heat energy for the drying process. Then, the rolled substrate may be performed with subsequent processing to form the sanitary mask or other articles, such as anti-UV umbrella fabric, anti-UV shade fabric. If necessary, the soft substrate may be coated with a buffer layer or a protective layer.

The present invention may employ non-metal or non-metallic oxide materials as the anti-UV material to avoid environmental pollution. The flexible substrate may be utilized such that the material may be manufactured into thin films on large scale via the roll to roll device of the present invention and the manufacturing process will not pollute the environment. The rotation speed of the axis of rotation may be controlled to control the growth thickness of the thin film and render the thin film to be attached to irregular or uneven surfaces.

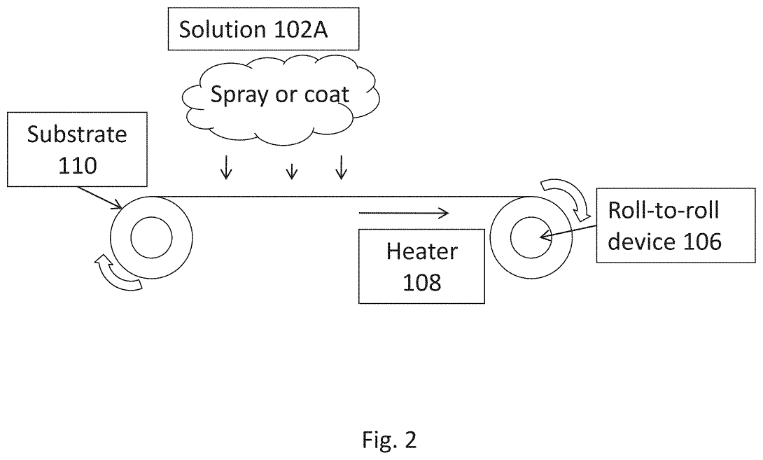

Please refer to FIG. 2 which shows one embodiment of the present invention. In this embodiment, the devices are similar to those in FIG. 1. The difference between this embodiment and the embodiment shown in FIG. 1 is that this embodiment employs coating, spray coating or inkjet printing to coat the desired soft substrate with the solution. After the solution is prepared, the inkjet printing, spray coating, printing or coating process may be performed to distribute the material onto the soft substrate. If the inkjet printing process is utilized, dye pattern may be printed onto the soft substrate directly and the remaining steps including optionally heating are similar to those in the previous embodiment.

The fabric surface of the anti-UV mask may be spray coated, printed or coated with the anti-UV absorbent material or photochromic dye to achieve the anti-UV function. If the anti-UV coating is spray coated on the surface, the color change of the mask may be observed, thereby indicating the function of anti-UV. The traditional mask is not available to offer the anti-UV function, let alone observing the protective effect thereof. Actually, the traditional mask fails to provide any protection and thus is disadvantageous to the care after facial cosmetic surgery. The prevention from UV radiation is the most important procedure for the care after cosmetic surgery. Therefore, the present invention offers advantages of the skin care after cosmetic surgery. The traditional mask cannot achieve the aforementioned function at all.

The present invention dopes resin for example aqueous resin or oleo-resin with the photochromic dye, and may mix the photochromic dye with the resin, the type of the photochromic dye is in the form of micro powders, capsules or liquid. For instance, the aqueous resin may be employed to mix with the hydrophilous photochromic dye to form the dip solution. The mixing ratio of the photochromic dye and the resin may be about 1:5 to about 1:20, wherein the dip solution may be diluted with water or solvent to adjust the viscosity thereof. The photochromic dye may absorb sunlight or ultraviolet radiation, and the chemical structure of the photochromic dye is changed after receiving the radiation. The photochromic dye can generate reversible chemical change after illuminated by the sunlight or UV radiation, thereby resulting in change of color. When not illuminated by the sunlight or UV light, the color of the mask changes back to the original color. The photochromic dye may be optionally doped in the resin together with light stabilizer and UV absorber to assist in absorbing UV radiation. Adding antioxidant or/and UV absorber into the resin can enhance the anti-light fatigue. In an alternative embodiment, the oil photochromic dye may be employed to cooperate with the resin, so as to perform manufacturing by printing or inkjet printing. The mixing volumetric percentage (ratio) of the oil photochromic dye and the resin is about 0.2-0.55.

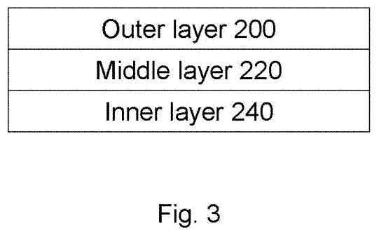

Therefore, please refer to FIG. 3, which illustrates a cross-sectional diagram of the mask of the present invention. The mask of the present invention may include three layers or four layers or more. In one embodiment, the sanitary mask includes an outer layer 200 as an anti-ultraviolet layer, the manufacturing method of which may refer to the aforementioned methods. The middle layer 220 may be a filter layer to filter out dust, bacteria, etc., and the inner layer 240 may be a heat generating layer or heat storage layer to provide the effect of keeping warm. The scent substrate may also be manufactured in the inner layer via the aforementioned methods. Scent, essence, essential oil, perfume raw material, etc. may be added into the substrate in the inner layer to obtain the scent substrate and enhance the effect. Lysozyme or degerming enzyme may be added into the outer layer or the middle layer by spray coating, dipping, coating or printing to eliminate bacteria. The traditional mask can only filter out bacteria and fails to kill bacteria. Therefore, the present invention can decompose bacteria with enzyme in addition to filtering. Moreover, anti-virus medicine may also be attached to the outer layer 200 or the middle layer 220 by spray coating, dipping or coating to suppress the influenza virus, enterovirus, etc. The filtering layer 220 may employ an ultra-micro-perforated filtering membrane (nano-micro-perforated Poly(tetrafluoroethene); PTFE membrane), which can filter out particles smaller than 0.1-2.5 micrometers to restrain the damage caused by PM 2.5, can have anti-haze function and is air-permeable, such that the user can breathe easily when wearing the sanitary mask. The nano-micro-perforated polytetrafluoroethylene (PTFE) membrane has aperture smaller than that of common micro-perforated membrane, and is highly hydrophobic and highly lipophobic, so as to have excellent moisture permeability, air permeability, water-proof property and oil-proof property. The PTFE nano-micro-perforated membrane which can endure ultra-high water pressure and has ultra-high moisture permeability and air permeability is made of polytetrafluoroethylene material in ultra-highly crystalline state by being extruded into membranes under ultra-high pressure with extremely fast stretching speed, such that the membrane can have nano-micro-perforated three-dimensional structure with ultra-high strength. The aperture of the membrane may be controlled between 0.03 μm (30 nm) and 15 μm, the thickness of the membrane may be 8˜50 μm, and the porosity of the membrane may reach 80˜97%. The ultra-micro-perforated biotechnological filtering membrane replaces the traditional unwoven fabric filtering layer with polymer membrane filtering material, and the filtration rate thereof reaches and is above 99.9%. The ultra-micro-perforated biotechnological filtering membrane can eliminate virus, allergen, fine and suspended particles in the air, is highly air-permeable and is not suffocating.

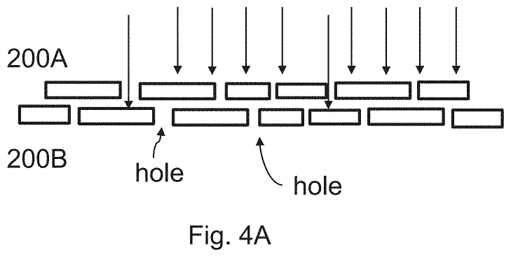

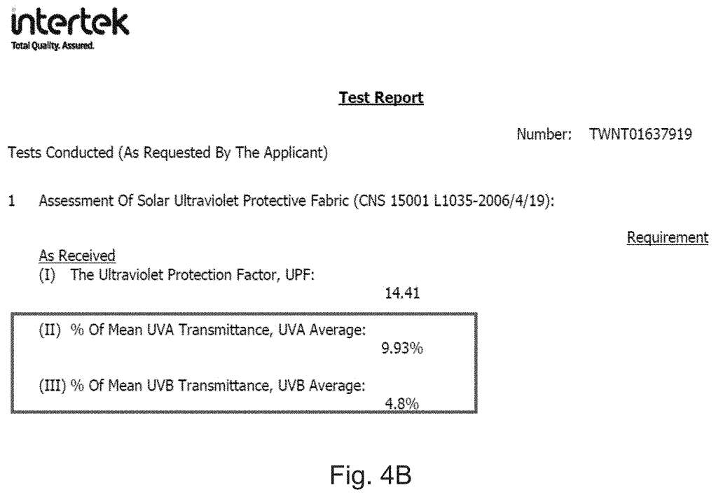

The ultraviolet radiation with a wavelength from 100 nm to 280 nm has shorter wavelength and stronger energy. The most harmful to the skin is UVC which is mostly isolated by ozone layer in atmospheric layer and almost fails to reach the ground. The UV radiation with a wavelength from 280 nm to 320 nm has lower energy than that of UVC and can induce immediate sunburn of the skin and cause skin cutin thickening, darker skin, erythrosis, conjuncitivitis, painful and drier skin, which are mainly because of UVB. According to this embodiment, the sanitary mask of the present invention can absorb most of the UV radiation. For example, the transmittance of the UV radiation with a wavelength below 310 nm is about 10%-12%, and the transmittance of UVA gradually enhances to 15%. The main reason is that the rate of gas exchange of the mask must fulfill related requirement and therefore the mask cannot be completely airtight. Thus, there are many irregular holes in the surface layer of the sanitary mask to render the ultraviolet ray to pass therethrough. Therefore, even if the surface layer is entirely coated with the absorbent, the absorption of the ultraviolet radiation cannot be downgraded continuously. However, in another embodiment, the present invention discloses a dual-layer anti-UV layer as shown in FIG. 4. The dual-layer anti-UV layer includes two layers of anti-UV layers 200A and 200B. The first anti-UV layer 200A employs unwoven fabric, and thus the holes therein are irregular and are randomly distributed, not regularly distributed. In the same way, the second anti-UV layer 200B utilizes unwoven fabric, and therefore the holes therein are also irregular and are also randomly distributed, not regularly distributed. Thus, the holes in the two layers of anti-UV structures rarely overlap. The ultraviolet light which fortunately passes through the holes in the first anti-UV layer 200A will mostly be absorbed or blocked by the second anti-UV layer 200B. Thus, the present invention greatly enhances the UV filtering effect. The transmittance of the UVB is only about 5%. Please refer to FIG. 4B, which is the test report made by Intertek which is an inspection institution in England with more than 120 years of history. If the amount of the UV absorbent material is increased by 5%, the transmittance of UVB is downgraded to about 3%. The first anti-UV layer 200A may employ hydrophobic fabric to prevent infectious droplet from spraying into the mask while the second anti-UV layer 200B may utilize hydrophobic fabric or hydrophilic fabric. The first anti-UV layer 200A may be doped with UV absorbent or photochromic dye, and the second anti-UV layer 200B may also be doped with UV absorbent or photochromic dye. The first anti-UV layer 200A may be coated or printed with UV absorbent or photochromic dye while the second anti-UV layer 200B may also be coated or printed with UV absorbent or photochromic dye. Although the present invention takes the dual layers as an example to describe one embodiment of the present invention, three layers may also be employed. However, it should be noted that the air permeability or the pressure difference must be fulfilled.

Zirconium oxide may be added into the fiber of the inner layer, so as to transform the visible light into the far-infrared ray to release thermal energy. In another embodiment, the heat generating fiber such as polyacrylate may be woven into the fabric. Thus, the fiber itself can absorb moisture and generate heat, and thus the fiber can absorb the water vapor released by the human body and release the heat when condensing the water vapor into water. The element generating infrared ray, for example ceramic material, may be added, such that the visible light may be absorbed, be transformed into infrared ray and be further transformed into thermal energy to enhance the temperature. Wool may also be employed to absorb the water vapor from the human body and generate and release heat of condensation. The far-infrared ray ceramic component such as zirconium oxide, zirconium carhide, etc may be added into the fiber to reflect the far-infrared ray emitted by the human body and transform it into thermal energy, so as to achieve heat generating effect. The heat generating fiber acrylate is a material which can generate heat by itself and warm the human body. The heat generating fiber can generate heat by absorbing the sweat and moisture from the human body, so as to render the space within the clothe to keep warm and comfortable. Acrylate can also deodorize the acidic odor or the alkaline odor via neutralization. The moisture in the human body can be absorbed by utilizing condensation heat effect. When the moisture is liquidized, the temperature will be released and the temperature is referred to as the condensation point. The heat generating fiber, Acrylate, absorbs the temperature released when the invisible water vapor is transformed (liquidized) into water (liquidization) at the condensation point and releases it again. In another embodiment, the skin friendly material, for example TENCEL acrylic fiber, may be employed to control the heat convection and prevent the thermal radiation from being emitted.

The hollow fiber section may render the fabric lighter in addition to relatively lowering the specific gravity of the fiber, and can effectively retain and isolate the air to achieve the thermal insulating effect. The section of the fiber is hollow, such that the air layer in the fiber can prevent the body temperature from losing to achieve the effect of keeping warm. The superfine fiber employed by the warmth keeping material is the superfine fiber with diameter less than 2 μm. PET fiber unwoven fabric can effectively retain more isolated air and reflect the heat radiated from the human body.

PCM (phase change material), for instance Outlast® fiber, can render the fabric to have special functions of absorbing heat and releasing heat to achieve extremely good warmth keeping effect. PCM can adjust and balance with microclimate areas among the clothes of the human body and surrounding environment continuously, so as to adjust the overtemperature and overcooling temperature to the most proper level. The excess heat from the human body can be absorbed, such that the moisture of the clothes can be downgraded and the comfortability of the wearer can be kept; when the amount of exercise decreases or the exercise ends, the stored heat energy is released, so that the wearer will not be affected by the cold.

Moreover, the HEPA (high-efficiency particulate air) may also be employed as the filtering layer. In other words, the HEPA filtering layer is high efficiency particulate air filtering gauze. The filter material of the high efficiency filtering gauze is usually made of irregular chemical fiber, such as unwoven fabric of polypropylene fiber or polyester fiber or glass fiber. The floccus structure with diameter of about 0.5 to 2.0 micro meter is utilized to remove particles. Alternatively, the polymer composed of hydrophobic material and hydrophilic material may also be employed, where there is molecular chain structure in the hydrophilic material and positive and negative charges are carried on the molecular chain to adsorb single water vapor molecule, so as to accelerate the speed of water vapor passing through the thin film. For instance, polyester-ether (TPEE) material composed by 70% polyester(hydrophobic) and 30% polyether ester(hydrophilic) may be utilized. The employed polyether ester can render the product to have recyclable concept. The hydrophilic molecules absorb water vapor and employ physical-chemical process to quickly drain water vapor out of the fabric layer. The thickness of the thin film is only 5 μm and thus is one of the most light-weight product on the market. Furthermore, the polyester fiber may be utilized to manufacture the thin and durable thin film, which has high-level waterproof and air permeable functions, such as the thin film commercially available as ECO STORM. Moreover, the film material made of TEEE (copolymer of phenyl ester and polyether diol) may be utilized. The film material can release water vapor by absorption and diffusion, have imporosity which thus will not cause obstruction, have the water vapor transmission rate of 8000-10000 g/m2/day after fitting and belong to high water vapor transmission rate thin film: waterproof, air permeable, having flexibility, recyclable and reusable. In another embodiment, the thin film commercially available as DINTEX® may be employed. The thin film is mainly composed of high molecular polyurethane elastomer (TPU) and has good flexibility and high strength. The thin film has a thickness of only 0.012-0.025 mm regarding waterproof property, and introduces hydrophilic group into the material to have extremely good water vapor permeability in addition to high waterproof property. The thin film can cooperate with fitting processing technology in textile industry, greatly enhance its additional value, have good weatherability, be environmental, have no toxicity, be recyclable and be decomposable. In one embodiment, holes and passages may be formed in PU resin by the solvent by employing water bath exchanging method or hot blast method to achieve water vapor permeable effect. The main structure of the polyurethane (TPU) molecules is simple and contains nitrogen, hydrogen, carbon and oxygen, and thus the polyurethane has no air pollution when burnt in the incinerator. Furthermore, polypropylene (PP), polyethylene (PE) perforated film may be employed and is manufactured by mulling calcium carbonate powder and PE and PP resin via dual-direction stretching method by utilizing the incompatible interface property between the calcium carbonate powder and the resin. The filtering film is supported by high molecular polymer layer at two sides.

In another embodiment, a warmth keeping layer 210 may be formed between the outer layer 200 and the inner layer 240 and may be formed at the inner side or outer side of the middle layer (filtering layer) 220. The warmth keeping layer 210 may include iron powder cement, table salt, silicate and activated carbon. The heat generating component is the iron powder, and other materials assist in oxidation-reduction reaction. When the iron powder contacts the oxygen in the air, the oxidation-reduction reaction begins. The equation is as follows:

4Fe(s)+3O₂(g)→2Fe₂O₃(s) ΔH=−826KJ/mol

A heat of 826KJ will be released when one mole of iron is oxidized into iron oxide. About ten grams of iron powder can approximately provide a heat of about 35927 cal after completely reacted. Vermiculite is one kind of silicate mineral, has many holes and is water retentive like activated carbon. The two additives can quickly absorb the water vapor in the air after contacting the air. The salt can facilitate the transfer of electrons and ions when dissolved and accelerate the oxidation reaction of iron. Magnesium or zinc, which are more reactive than iron, can replace all or part of iron.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A sanitary mask, comprising:
a first anti-UV layer having a plurality of first holes distributed irregularly;
a second anti-UV layer having a plurality of second holes distributed irregularly and disposed adjacent to said first anti-UV layer;
a filtering layer disposed adjacent to said second anti-UV layer; and
an inner layer disposed adjacent to said filtering layer.

2. The mask of claim 1, wherein said first anti-UV layer includes UV absorbent or photochromic dye or the combination thereof.

3. The mask of claim 2, wherein said second anti-UV layer includes UV absorbent or photochromic dye or the combination thereof.

4. The mask of claim 1, wherein said plurality of first holes are arranged randomly

5. The mask of claim 1, wherein said plurality of second holes are arranged randomly.

6. The mask of claim 1, wherein if a whole amount of anti-UV compositions is fixed, said first anti-UV layer and said second anti-UV layer include a half of said whole amount of anti-UV compositions respectively.

7. The mask of claim 1, wherein a material of said filtering layer includes one of HEPA, polyester-ether (TPEE), copolymer of phenyl ester and polyether diol (TEEE), polyurethane elastomer (TPU), Poly(tetrafluoroethene)(PTFE), polypropylene (PP), polyethylene (PE).

8. The mask of claim 1, wherein said filtering layer includes antibacterial composition, enzyme or anti-influenza substance or the combination thereof.

9. The mask of claim 1, wherein a material of said inner layer includes hollow fiber, phase change fiber, ceramic material fiber or heat generating fiber or the combination thereof.

10. A sanitary mask, comprising:
a first anti-UV layer having a plurality of first holes distributed irregularly, said first anti-UV layer including a first photochromic dye;
a second anti-UV layer having a plurality of second holes distributed irregularly and disposed adjacent to said first anti-UV layer, said second anti-UV layer including a second photochromic dye;
a filtering layer disposed adjacent to said second anti-UV layer; and
an inner layer disposed adjacent to said filtering layer.

11. The mask of claim 10, wherein said plurality of first holes are arranged randomly.

12. The mask of claim 10, wherein said plurality of second holes are arranged randomly.

13. The mask of claim 10, wherein an amount of said first photochromic dye is about equivalent to an amount of said second photochromic dye.

14. The mask of claim 10, wherein a color of said first photochromic dye is identical to a color of said second photochromic dye.

15. The mask of claim 10, wherein a color of said first photochromic dye is different from a color of said second photochromic dye.

16. The mask of claim 10, wherein a material of said filtering layer includes one of HEPA, polyester-ether (TPEE), copolymer of phenyl ester and polyether diol (TEEE), polyurethane elastomer (TPU), Poly(tetrafluoroethene)(PTFE), polypropylene (PP), polyethylene (PE).

17. The mask of claim 10, wherein said filtering layer includes antibacterial composition, enzyme or anti-influenza substance or the combination thereof.

18. The mask of claim 10, wherein a material of said inner layer includes hollow fiber, phase change fiber, ceramic material fiber or heat generating fiber or the combination thereof.
